(19) United States
(12) Patent Application Publication
(10) Pub. No.: US 2008/0002634 A1
(43) Pub. Date: Jan. 3, 2008

(54) SELECTIVE CONTROL OF DEVICE PARAMETERS BASED UPON IDENTIFICATION OF OTHER DEVICES IN A PERSONAL AREA NETWORK

(75) Inventors: Von A. Mock, Boynton Beach, FL (US); Mark A. Barros, Wellington, FL (US); Jorge L. Perdomo, Boca Raton, FL (US); Charles P. Schultz, North Miami Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/427,797

(22) Filed: Jun. 30, 2006

(51) Int. Cl. H04Q 7/24

(52) U.S. Cl. 370/338

(57) ABSTRACT

A method (500) for controlling operation of a mobile station. The method can include, on a first mobile station (110), monitoring for other mobile stations (115, 120) within a personal area network. Responsive to identifying at least a second mobile station within the personal area network, at least one operating parameter on the first mobile station can be automatically modified. Modifying the operating parameter can include, for example, automatically communicating an identifier (130) associated with the second mobile station to a third communication device (125), for instance by sending an e-mail, sending a text message or placing a call. In another arrangement, at least one call handling function can be changed in response to matching the identifier with a second identifier contained in the list of known identifiers.

### BACKGROUND OF THE INVENTION

1. Field of the Invention

The present invention generally relates to mobile communications and, more particularly, to mobile stations operating within a personal area network.

2. Background of the Invention

The use of mobile stations has grown to an extent that such devices are now ubiquitous throughout most of the industrialized world. Just as their use has grown, so too has the functionality of the mobile stations. Indeed, mobile stations now can be used not only for voice communications, but also to perform a number of other functions. For example, mobile stations can be used to browse the Internet, send and receive e-mail and instant messages, play games, take photographs and capture video. Moreover, mobile stations also can communicate with other devices, such as mobile station accessories defined within the mobile station's personal area network.

Notwithstanding the convenience mobile stations bring to modern life, their use is not always desirable. For example, a mobile station may receive a call from a particular person at an inopportune time. Although the mobile station can be turned off to avoid such a call, it then would not be possible to retrieve calls from other people with whom a mobile station user wishes to communicate. Thus, further customizable options for mobile station functionality are desirable.

### SUMMARY OF THE INVENTION

The present invention relates to a method for controlling operation of a mobile station. The method can include, on a first mobile station, monitoring for other mobile stations within a personal area network. Responsive to identifying at least a second mobile station within the personal area network, at least one operating parameter on the first mobile station can be automatically modified.

Modifying the operating parameter can include, for example, automatically communicating a first identifier associated with the second mobile station to a third communication device, for instance by sending an e-mail, sending a text message or placing a call. A message can be received from the third communication device in response to the third communication device matching the first identifier associated with the second mobile station to a second identifier contained in a list of known identifiers.

In another arrangement, modifying the operating parameter can include automatically communicating a call handling change request to a third communication device. The change request can request that a received call be routed to voice mail and/or that a voice mail greeting be changed. In yet another arrangement, modifying the operating parameter can include automatically turning off the mobile station.

In another aspect of the invention, a first identifier associated with the second mobile station can be compared to identifiers contained in a list of known identifiers. In such an arrangement, modifying the operating parameter can include changing at least one call handling function in response to matching the first identifier with a second identifier contained in the list of known identifiers. Further, a call can be received from a third communication device, and a third identifier associated with the third communication device can be compared to identifiers contained in a second list of known identifiers. Responsive to matching the third identifier with a fourth identifier contained in the list, the call can be sent to voice mail.

In yet another aspect of the invention, automatically modifying the operating parameter can include selecting an advertisement to be presented, selecting a radio preset on the mobile station, presenting an event recommendation or presenting a contact/friend recommendation. Automatically modifying the operating parameter also can include choosing an availability indicator, choosing a network preference or choosing a network service. In yet another arrangement, automatically modifying the operating parameter can include modifying a frequency of a health reading or modifying a health status range.

The present invention also relates to a method for controlling operation of a mobile station that includes, on the mobile station, monitoring for other communication devices. Responsive to identifying at least a first communication device, a priority of the first communication device can be determined and, based on the priority, at least one operating parameter on the mobile station can be modified. Determining a priority of the first communication device can include comparing a first identifier associated with the first communication device to identifiers contained in a list of known identifiers and, in response to matching the first identifier with a second identifier contained in the list of known identifiers, selecting a priority level associated with the second identifier. Modifying the operating parameter can include automatically changing at least one call handling function. For example, a received call can be automatically sent to voice mail. Further, a voice mail greeting can be changed.

The present invention also relates to a first mobile station that includes a personal area network (PAN) adapter that detects a first identifier associated with at least a second mobile station. The mobile station also can include a controller that, responsive to detecting the first identifier, automatically modifies at least one operating parameter on the first mobile station. The mobile station also can include a communications adapter that communicates the first identifier to a third communication device.

In one arrangement, the controller can compare the first identifier to identifiers contained in a list of known identifiers. In such an arrangement, the mobile station can include a communications adapter that communicates a message to a third communication device in response to the controller matching the first identifier with a second identifier contained in the list of known identifiers.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts another arrangement of the communications system that is useful for understanding the present invention;

FIG. 3 depicts yet another arrangement of the communications system that is useful for understanding the present invention;

FIG. 4 depicts a block diagram of a mobile station that is useful for understanding the present invention;

FIG. 5 is a flowchart that is useful for understanding the present invention;

FIG. 6 is another flowchart that is useful for understanding the present invention; and

FIG. 7 is yet another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for identifying other devices within a mobile station's personal area network (PAN) and, in response, selectively controlling one or more of the mobile station's operating parameters. For example, if the mobile station is a slave to a master station, identifiers for other devices within the mobile station's PAN can be communicated to the master station. Thus, a parent having a master station can provide her child with a slave station and, via her master station, maintain a level of awareness of her child's surroundings.

In another arrangement, the behavior of the mobile station can be changed based on the other devices that are detected within the PAN. For example, if a mobile station belonging to a teenager detects that a mobile station belonging to her parent is in close proximity, the teenager's mobile station can route calls from her boyfriend straight to voice mail. Moreover, the voice mail greeting can be selected based on such detection.

FIG. 1 depicts a communications system 100 that is useful for understanding the present invention. The communications system 100 can include a communications network 105, which can comprise, for example, the Internet, the World Wide Web, a wide area network (WAN), a local area network (LAN), a cellular communications network, a dispatch communications network, a public switched telephone network (PSTN), and/or any other networks or systems over which communication signals can be propagated. In that regard, the communications network can include wired and/or wireless communication links.

The communications system 100 also can include a mobile station 110 and one or more mobile stations 115, 120. The mobile stations 110, 115, 120 can be, for example, mobile computers, personal digital assistants (PDAs), mobile telephones, such as a cellular telephones or a push-to-talk (PTT) telephones, game consoles, or any other mobile electronic apparatuses that may be used to communicate via a communications network 110. In another arrangement, the mobile stations 115, 120 can be RF identifiers (RFIDs) that are detectable by the mobile station 110.

A communication device 125 also can be provided. The communication device 125 can be a mobile station, a telephone, a computer, a server, or any other electronic apparatus that may receive communications from the mobile station 110 via the communications network 105. In one arrangement, the communication device 125 can be a master device, and the mobile station 110 can be a slave device associated with the communication 125. For example, the communication device 125 can belong to a primary account holder for a communications service (e.g. a parent), and the mobile station 110 can belong to an authorized user of the account (e.g. child).

In operation, the mobile station 110 can monitor for other devices, such as the mobile stations 115, 120, within the PAN of the mobile station 110. As used herein, a PAN is a computer network used for wireless communication among devices within close proximity to each other, for instance devices that are within one hundred meters of each other, or less. For example, the mobile station 110 can monitor for identifiers 130, 135 broadcast by the respective mobile stations 115, 120 in accordance with a suitable communications protocol, such as Bluetooth or ZigBee. In response to receiving at least one of the identifiers 115, 120, at least one operating parameter on the mobile station 110 can be modified. For example, the mobile station 110 can enter an operational mode in which it communicates the identifiers 115, 120 to the communication device 125. The mobile station 110 can communicate the identifiers 115, 120 by sending an e-mail or a text message to the communication device 125, or placing a call to the communication device 125.

In one arrangement, the identifiers 115, 120 can be compared to a list 140 of known identifiers. The list 140 can be accessed by the communication device 125, in which case the comparison can be performed by the communication device 125. The list 140 can be stored on the communication device 125, or stored on another device to which the communication device 125 is communicatively linked, for example via the communications network 105. In response to one or more of the identifiers 115, 120 matching an identifier contained in the list 140, an alert can be generated. For example, an audio signal and/or a visual indicator can be presented by the communication device 125. In addition, a message 145 can be sent from the communication device 125 to the mobile station 110 indicating the alert. In response, an audio signal and/or a visual indicator can be presented by the mobile station 110. In another arrangement, the audio signal and/or a visual indicator can be presented by another communication device (not shown).

Advantageously, a user, such as a parent, can add to the list 140 of identifiers one or more people who should not be within the PAN of his child's mobile station 110. If any such people are close enough to be detected by the mobile station 110, the parent can be immediately alerted. In another arrangement, the list 140 can be maintained by a company or agency, and identifiers for certain individuals, such as known pedophiles, can be contained in the list 140.

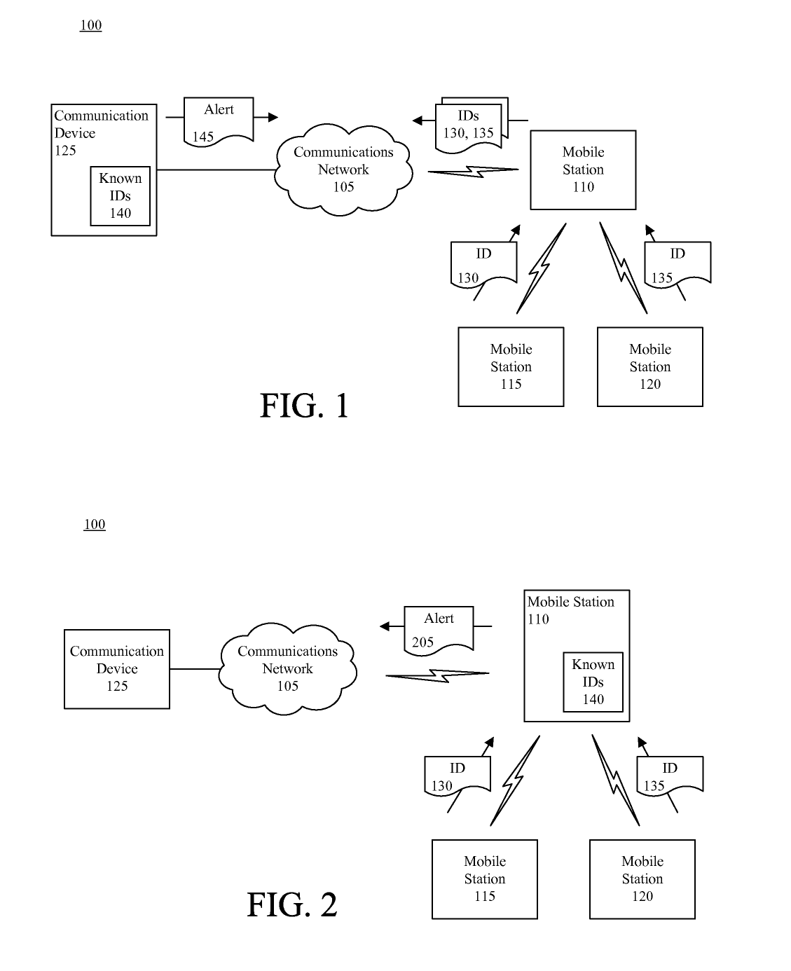

FIG. 2 depicts another arrangement of the communications system 100 in which the list 140 of identifiers can be accessed by the mobile station 110. The list 140 can be stored on the mobile station 110, or stored on another device to which the mobile station 110 is communicatively linked, for example via the communications network 105. In response to one or more of the identifiers 115, 120 matching an identifier contained in the list 140, a message, such as an alert 205, can be communicated from the mobile station 110 to the communication device 125. As noted, an audio signal and/or a visual indicator can be presented by the communication device 125. An audio signal and/or a visual indicator also can be presented by the mobile station 110.

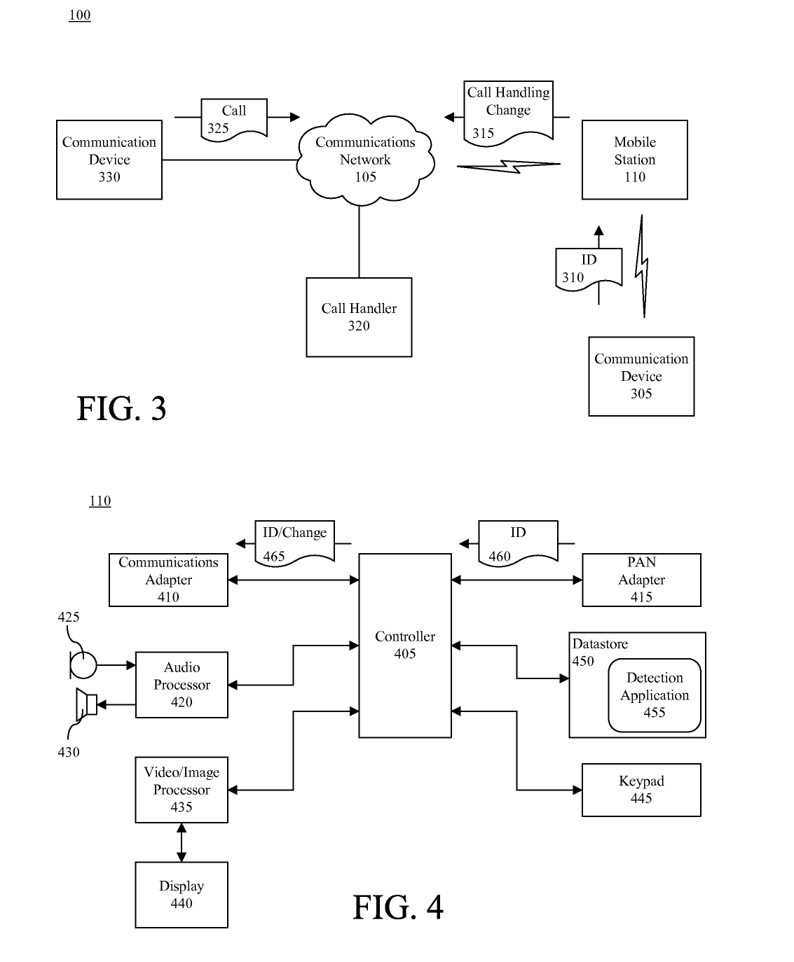

FIG. 3 depicts yet another arrangement of the communications system 100. In operation, the mobile station 110 can receive an identifier 310 from a communication device 305. The communication device 305 can be a mobile station, an RFID, a transponder, or any other communication device suitable for broadcasting the identifier 310. In response to the mobile station 110 receiving the identifier 310, at least one operating parameter on the mobile station 110 can be modified. For example, in one arrangement, the communication device 305 can be a transponder in an emergency room of a hospital. Many hospitals do not allow mobile stations to be used within an emergency room. In such an arrangement, the modification to the operating parameter can cause the mobile station to automatically turn off.

The operating parameter change also can trigger the mobile station 110 to communicate a call handling change request 315 to a call handler 320. The call handler 320 can be a mobile switching center (MSC), a basestation controller (BSC), a base transceiver station (BTS), a gateway or any other device which can rout calls and/or provide voice mail services. The call handling change request 315 can request that one or more calls 325 placed to the mobile station 110 from other communication devices, such as a communication device 330, be automatically routed to voice mail. The call handling request 315 also can request a voice mail greeting be automatically changed. For example, the voice mail greeting can be changed to indicate that a user associated with the mobile station 110 is at the hospital. Further, based on the identifier 310, the voice mail greeting also can indicate at which hospitable the user is presently located. In another arrangement, the voice mail greeting can be a standard voice mail greeting or a voice mail greeting recorded by the user. Still, any other voice mail greeting can be presented and the invention is not limited in this regard.

In another arrangement, the communication device 305 can be a mobile station, transponder or RFID associated with a particular person or place. If a user of the mobile station 110 wishes not to receive calls from one or more people when with the that person or at that place, the call handing change request 315 can indicate to the call handler 320 to route all calls or a particular call, such as call 325, to voice mail. For example, a user of the mobile station 110 who is a company executive may wish to route to voice mail all calls received while the executive is present in a company's board room. Similarly, a user of the mobile station 110 may wish to route to voice mail calls from her boyfriend while the mobile station 110 is in proximity the user's parents.

In yet another arrangement, a priority level can be assigned to the identifier 310. For example, when the identifier 310 is received, the identifier 310 can be compared to identifiers contained in a list of known identifiers. In response to matching the identifier 310 with a second identifier contained in the list, a priority level associated with the second identifier can be selected and assigned to the identifier 310. The call handling change request 315 then can be selected based on the assigned priority level.

For example, if the communication device 305 is a transponder in a hospital emergency room, the identifier 310 can be assigned a first priority level. When the identifier 310 is assigned the first priority level, the call handling change request 315 can requests that all calls 325 be routed to voice mail. If the communication device 305 is a parent's mobile station, the identifier may be assigned a second priority level in which the call handling change request 315 requests only that calls 325 from certain people are routed to voice mail. If the communication device 305 is a transponder in a board room, a third priority level can be assigned in which only calls 325 from certain people are routed to the mobile station 110, while all other calls are routed to voice mail.

Other operating parameters of the mobile station 110 also may be selectively changed. Such changes can include, for instance, selecting an advertisement to be presented, selecting a radio preset on the mobile station, presenting an event recommendation or presenting a contact/friend recommendation. In addition, changing an operating parameter can include choosing an availability indicator, choosing a network preference or choosing a network service. In another arrangement in which the mobile station 110 also happens to also be monitoring health parameters using techniques known in the art, changing an operating parameter can include changing a frequency of a health reading or changing an acceptable health status range.

Still, a myriad of other operating parameters may be selectively changed, and such changes can be triggered by any of a myriad of circumstances. Examples of other parameters that may be changed include, but are not limited to, a theme, a background image, a ringtone, an alert, an audio volume, a speakerphone activation status, an order in which favorites are presented in a list, a multimedia playlist, an item visible on a calendar, a photo that is visible in a photo album, a call that is shown in a call list, a radio present, a task on a task list, a blog that is listed, a podcast that is listed, an identifier of a person contained in a list, an availability indicator, a network preference, a network selection, a network service, an advertisement to be presented, a multimedia recommendation, or an information service selection.

In order to facilitate selection of operating parameters that are to be selectively changed and to define when to change such parameters, one or more menus of user selectable operating parameters can be presented by the mobile station 110. For example, the menus can be presented on a display of the mobile station 110. In addition, user selectable circumstances for initiating the changes to the operating parameters can be presented. In the present example, the user of the mobile station 110 can select, or enter, a particular identifier 310 and select an operating parameter to be changed when that identifier 310 is detected. In an arrangement in which the operating parameter relates to changing routing of a call, the menu can receive user selections or inputs to select which calls are to be subject to the changed call routing. For instance, the user can enter one or more particular telephone numbers or caller identifiers, or select all calls.

FIG. 4 depicts a block diagram of a mobile station 110 that is useful for understanding the present invention. The mobile station 110 can include a controller 405. The controller 405 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The mobile station 110 also can include a communications adapter 410 that is used by the mobile station 110 to communicate with the communications network. The communications adapter 410 can include, for example, a transceiver that communicates data via IEEE 802 wireless communications, WPA, WPA2, GSM, TDMA, CDMA, WCDMA, direct wireless communication, TCP/IP, or any other suitable form of mobile communications.

A PAN adapter 415 also can be provided to detect identifiers from other communication devices, such as mobile stations, transponders and RFIDs. For example, the PAN adapter 415 can include a transceiver or receiver configured to detect signals or beacons broadcast in accordance with the Bluetooth protocol or the ZigBee protocol. In arrangement in which the PAN adapter 415 comprises a transceiver, the PAN adapter 415 also can communicate signals in accordance with such protocols. In one arrangement, the PAN adapter 415 can be integrated with the communications adapter 410.

The mobile station 110 also can include an audio processor 420 connected to an input audio transducer 425 (e.g. microphone) and an output audio transducer 430 (e.g. loudspeaker). The audio processor 420 can be integrated with the controller 405, or provided as a separate component that is communicatively linked to the controller 405. The audio processor 420 can comprise a CPU, a DSP, an ASIC, a PLD, a plurality of discrete components that cooperate to process audio data, and/or any other suitable audio processing device.

The audio processor 420 can receive input audio signals from a user via the input audio transducer 425, and propagate output audio signals to the user via the output audio transducer 430. In one arrangement, the audio processor 420 can audibly present menu items to a user via the output audio transducer 430 and receive audible user inputs via the input audio transducer 425 to select one or more of such menu items. In such an arrangement, the audio processor 420 can perform text-to-speech synthesis and speech recognition, both of which are known to the skilled artisan.

The mobile station 110 also can include a video/image processor 435 connected to a display 440. The video/image processor 435 can be integrated with the controller 405, or provided as a separate component that is communicatively linked to the controller 405. The video processor 435 can comprise a CPU, a DSP, an ASIC, a PLD, a plurality of discrete components that cooperate to process video data, and/or any other suitable audio processing device. The video processor 435 can present visual menus to the user via the display 440. The display 440 can be liquid crystal display (LCD), liquid crystal on silicon (LCOS) display, a plasma display, a cathode ray tube (CRT), or any other display suitable for presenting menu items. In one arrangement, the display can be a touch screen that receives tactile user inputs. In another arrangement, such inputs can be received via a keypad 445, or any other user input devices.

The mobile station 110 also can include a datastore 450. The datastore 450 can include a magnetic storage medium, an electronic storage medium, an optical storage medium, a magneto-optical storage medium, or any other storage medium suitable for storing digital information. In one arrangement, the datastore 450 can be integrated into the controller 405.

A detection application 455 can be contained on the datastore 450. The detection application 455 can be executed by the controller 405 to implement the methods and processes described herein. For example, the detection application 455 can be executed to process one or more identifiers 460 received by the PAN adapter 415 and generate one or more messages 465 to be communicated to one or more other communications devices by the communications adapter 410. A message 465 can contain an identifier correlating to a received identifier 460, or a call handling change request. The detection application 455 also can be processed to generate alerts, and/or implement any other suitable mobile station functions.

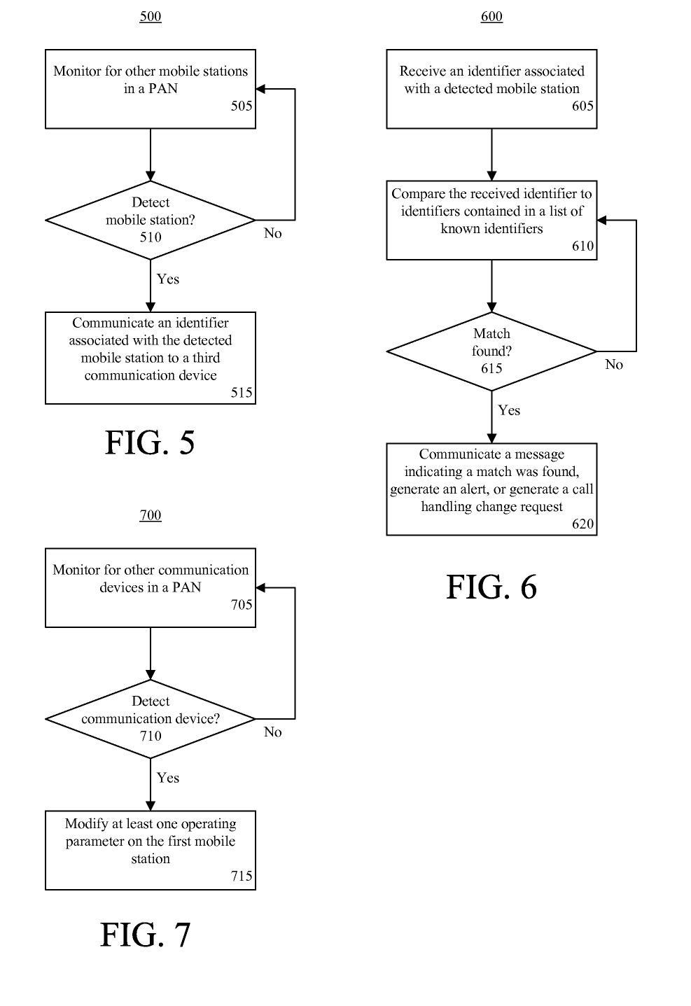

FIG. 5 is a flowchart presenting a method 500 that is useful for understanding the present invention. At step 505, a first mobile station can monitor for other mobile stations in a PAN of the first mobile station. Referring to decision box 510, if another mobile station is detected, at step 515 an identifier associated with the detected mobile station can be communicated to a third device.

FIG. 6 is another flowchart presenting a method 600 that is useful for understanding the present invention. At step 605, an identifier associated with a detected mobile station 605 can be received. Proceeding to step 610, the identifier can be compared to identifiers contained in a list of known identifiers. The comparison can be performed on a first mobile station that received the identifier from the detected mobile station, or on a communication device to which the first mobile station communicated the identifier. Referring to decision box 615, if a match to the received identifier is found in the list, at step 620 a message can be communicated indicating that a match was found, an alert can be generated, or a call handling change request can be generated.

FIG. 7 is yet another flowchart presenting a method 700 that is useful for understanding the present invention. At step 705, a mobile station can monitor for other communication device in a PAN. Referring to decision box 710, in response to a communication device being detected, at least one operating parameter on the first mobile station can be modified. For example, a call handling change request can be communicated to a call handler.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for controlling operation of a mobile station, comprising:
on a first mobile station, monitoring for other mobile stations within a personal area network;
responsive to identifying at least a second mobile station within the personal area network, automatically modifying at least one operating parameter on the first mobile station.

2. The method of claim 1, wherein automatically modifying the operating parameter comprises automatically communicating a first identifier associated with the second mobile station to a third communication device.

3. The method of claim 2, wherein automatically communicating the identifier comprises performing at least one communication function selected from the group consisting of sending an e-mail, sending a text message and placing a call.

4. The method of claim 2, further comprising receiving a message from the third communication device in response to the third communication device matching the first identifier with a second identifier contained in a list of known identifiers.

5. The method of claim 1, wherein automatically modifying the operating parameter comprises automatically communicating a call handling change request to a third communication device.

6. The method of claim 5, wherein communicating the call handling change request comprises requesting that a received call be routed to voice mail.

7. The method of claim 5, wherein communicating the call handling change request comprises requesting a change to a voice mail greeting.

8. The method of claim 1, wherein modifying the operating parameter comprises automatically turning off the mobile station.

9. The method of claim 1, further comprising:
comparing a first identifier associated with the second mobile station to identifiers contained in a list of known identifiers;
wherein modifying the operating parameter comprises communicating a message to a third communication device in response to matching the first identifier with a second identifier contained in the list of known identifiers.

10. The method of claim 9, further comprising:
receiving a call from a third communication device;
comparing a third identifier associated with the third communication device to identifiers contained in a second list of known identifiers; and
responsive to matching the third identifier with a fourth identifier contained in the list, sending the call to voice mail.

11. The method of claim 1, wherein automatically modifying the operating parameter comprises selecting an advertisement to be presented, selecting a radio preset on the mobile station, presenting an event recommendation or presenting a contact/friend recommendation.

12. The method of claim 1, wherein automatically modifying the operating parameter comprises choosing an availability indicator, choosing a network preference or choosing a network service.

13. The method of claim 1, wherein automatically modifying the operating parameter comprises modifying a frequency of a health reading or modifying a health status range.

14. A method for controlling operation of a mobile station, comprising:
on the mobile station, monitoring for other communication devices;
responsive to identifying at least a first communication device:
determining a priority of the first communication device; and
based on the priority, modifying at least one operating parameter on the mobile station.

15. The method of claim 14, wherein determining a priority of the first communication device comprises:
comparing a first identifier associated with the first communication device to identifiers contained in a list of known identifiers; and
in response to matching the first identifier with a second identifier contained in the list of known identifiers, selecting a priority level associated with the second identifier.

16. The method of claim 14, wherein modifying the operating parameter comprises automatically changing at least one call handling function.

17. The method of claim 16, wherein changing the call handling function comprises automatically sending a received call to voice mail.

18. The method of claim 16, wherein changing the call handling function comprises automatically changing a voice mail greeting.

19. A first mobile station, comprising:
a personal area network (PAN) adapter that detects a first identifier associated with at least a second mobile station; and
a controller that, responsive to detecting the first identifier, automatically modifies at least one operating parameter on the first mobile station.

20. The mobile station of claim 19, further comprising a communications adapter that communicates the first identifier to a third communication device.

21. The mobile station of claim 19, wherein the controller compares the first identifier to identifiers contained in a list of known identifiers.

22. The mobile station of claim 21, further comprising a communications adapter that communicates a message to a third communication device in response to the controller matching the first identifier with a second identifier contained in the list of known identifiers.
